(19) United States
(12) Patent Application Publication
(10) Pub. No.: US 2008/0055182 A1
(43) Pub. Date: Mar. 6, 2008

(54) INNER ANTENNA USING BALUN FOR MOBILE TERMINAL

(75) Inventor: Jong-In LEE, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/838,562

(22) Filed: Aug. 14, 2007

(30) Foreign Application Priority Data
Aug. 29, 2006 (KR) 2006-82150

(51) Int. Cl. H01Q 1/50

(52) U.S. Cl. 343/859

(57) ABSTRACT

An inner antenna of a mobile terminal using a balance-to-unbalance transformer (BALUN) that can expand a frequency bandwidth is provided. The inner antenna includes a radiation plate disposed at the surface of a wiring substrate provided within the main body of a mobile terminal and has a structure in which a BALUN chip is located between a ground pad to which the radiation plate is coupled and a duplexer. Because the BALUN performs the function of a transformer, the BALUN can slowly change impedance, whereby performance deterioration due to abrupt impedance change is reduced. Slow impedance change allows a slow rate of change of the impedance locus in a frequency, thereby expanding the bandwidth of the inner antenna.

### PRIORITY

This application claims priority to an application entitled “INNER ANTENNA USING BALUN FOR MOBILE TERMINAL” filed in the Korean Intellectual Property Office on Aug. 29, 2006 and assigned Serial No. 2006-82150, the contents of which are incorporated herein by reference.

### BACKGROUND OF THE INVENTION

1. Field of the Invention

The present invention relates to an antenna of a mobile terminal, and more particularly, to an inner antenna using a BALUN provided within a main body of a mobile terminal.

2. Description of the Related Art

In general, a mobile terminal transmits and receives radio waves through an antenna. A conventional antenna protrudes a predetermined height from an upper end of a main body in a mobile terminal. However, because a protruding antenna easily contacts other objects, it is somewhat inconvenient to carry the mobile terminal. Particularly, the protruding antenna is easily damaged upon impact.

In order to solve such a problem, a mobile terminal has been introduced in which an antenna is provided within the main body. The inner antenna is also called an ‘intenna’.

As shown in FIG. 1, a conventional inner antenna 100 of a mobile terminal includes a radiation plate 20 in a top part of a wiring substrate 10 provided within a main body. A ground pad 12 and a power supply pad 14 are formed on a surface of wiring substrate 10 under radiation plate 20. A ground unit and a power supply unit of radiation plate 20 are bonded to ground pad 12 and power supply pad 14, respectively. A strip line 16 is connected to power supply pad 14 and a duplexer 30.

Accordingly, a signal received in the mobile terminal is input to duplexer 30 via radiation plate 20 and strip line 16. A signal transmitted from the mobile terminal emits through radiation plate 20 via duplexer 30 and strip line 16.

However, in conventional inner antenna 100, because electromagnetic waves of a predetermined frequency band are emitted through radiation plate 20 if current is supplied to radiation plate 20 through power supply pad 14, a frequency bandwidth of electromagnetic waves that can radiate is limited. Accordingly, the structure of conventional inner antenna 100 is limited in expanding the frequency bandwidth.

When a mobile terminal is used for voice communication, a user generally uses the terminal by holding the main body with one hand and bringing the terminal close to the head, whereby a frequency shift due to the effect of the human body may be generated. However, because the frequency bandwidth of inner antenna 100 is limited, the shifted frequency may deviate from a predetermined frequency bandwidth of inner antenna 100. In this case, the antenna may not properly operate due to deterioration of the inner antenna performance.

### SUMMARY OF THE INVENTION

The present invention has been made in an effort to solve the above problems, and an object of the present invention is to provide an inner antenna that can expand the frequency bandwidth of an inner antenna.

Another object of the present invention is to provide an inner antenna that can maintain a stable antenna performance by minimizing performance deterioration even if a frequency shift is generated due to an effect of the human body.

In accordance with an aspect of the present invention, the above and other objects are accomplished by an inner antenna of a mobile terminal using a balance-to-unbalance transformer (BALUN) including a wiring substrate, a radiation plate, a strip line, and a BALUN chip. The wiring substrate is provided within a main body of the mobile terminal, and has a ground pad and a power supply pad on a surface thereof. The radiation plate is bonded to the ground pad and the power supply pad and separated from the surface of the wiring substrate. The strip line includes first and second strip lines. The first strip line is connected to the power supply pad and the second strip line is connected to a duplexer. The BALUN chip is connected to the first and second strip lines to expand the frequency bandwidth.

Preferably, the first strip line connected to the power supply pad is connected to the first input/output terminal of the BALUN chip; and the second strip line connected to the duplexer is connected to a second input/output terminal of the BALUN chip.

### BRIEF DESCRIPTION OF THE DRAWINGS

The above and other objects, features and advantages of the present invention will be more apparent from the following detailed description in conjunction with the accompanying drawings, in which:

FIG. 1 is a plan view of a conventional inner antenna of a mobile terminal;

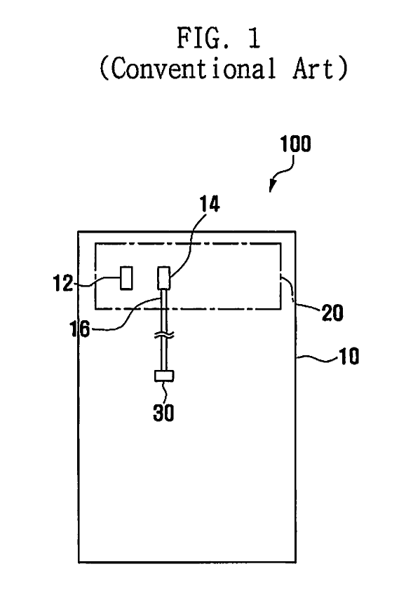

FIG. 2 is a plan view of an inner antenna of a mobile terminal using a BALUN according to the present invention; and

FIG. 3 is an enlarged view of portion “A” of FIG. 2.

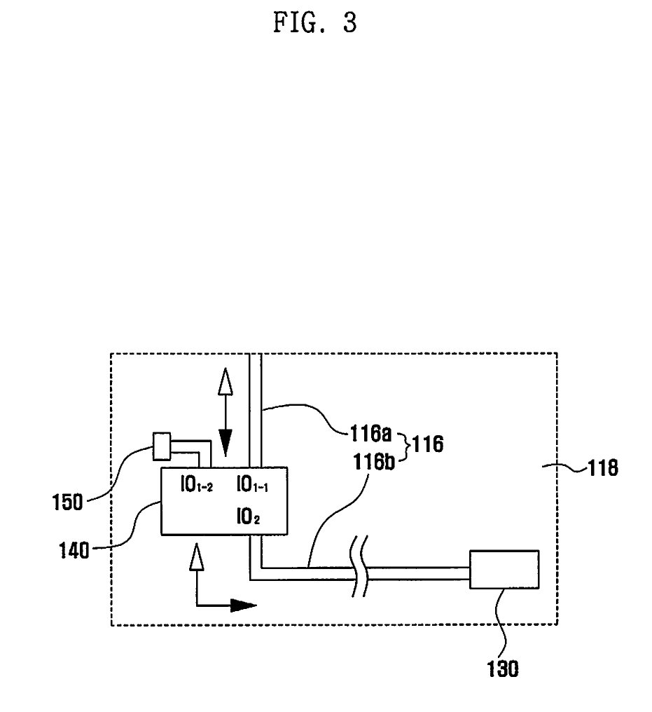

### DETAILED DESCRIPTION OF PREFERRED EMBODIMENTS

Preferred embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

While the present invention may be embodied in many different forms, specific embodiments of the present invention are shown in drawings and described herein in detail, with the understanding that the present disclosure is to be considered as an exemplification of the principles of the invention and is not intended to limit the invention to the specific embodiments illustrated.

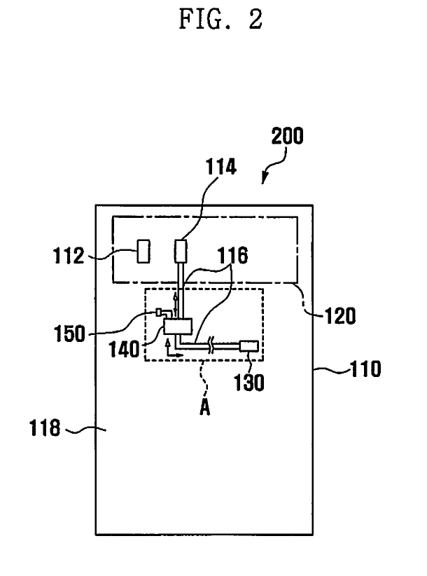

Referring to FIG. 2, an inner antenna 200 according to the present invention includes a wiring substrate 110, a radiation plate 120, a first and second strip lines 116, and a BALUN chip 140. Wiring substrate 110 is provided within a main body of the mobile terminal, and a ground pad 112 and a power supply pad 114 are formed on a surface of wiring substrate 110. Radiation plate 120 is bonded to ground pad 112 and power supply pad 114 and separated from the surface of wiring substrate 110. First strip line 116a is connected to power supply pad 114 and second strip line 116b is connected to a duplexer 130. BALUN chip 140 is connected to first and second strip lines 116a and 116b to expand the frequency bandwidth of inner antenna 200.

In more detail, wiring substrate 110 has a structure in which a multiple metal wiring layers are formed in a substrate body 118. Stacking a plurality of wiring substrates can form the multiple metal wiring layers. For example, a printed circuit board (PCB) or a tape wiring substrate can be used as wiring substrate 110. Many parts in addition to radiation plate 120 are mounted in wiring substrate 110, but a detailed description of these parts is not necessary for this description of the inner antenna 200 according to the present invention, and thus the parts are not shown in the drawings.

The metal wiring layer is made of copper and is formed by attaching a copper (Cu) foil to substrate body 118 and then patterning the Cu foil with a photolithography process. The metal wiring layer includes ground pad 112 and power supply pad 114 formed on a surface of substrate body 118 and strip line 116 connected to power supply pad 114. Ground pad 112 and power supply pad 114 are formed on an upper part of said surface of substrate body 118. Strip line 116 includes a first strip line 116a connecting power supply pad 114 and a first input/output terminal IO₁₋₁ of BALUN chip 140 and a second strip line 116b connecting a second input/output terminal IO₂ of BALUN chip 140 and duplexer 130. A reception signal input to the first input/output terminal IO₁₋₁ via first strip line 116a is output to the second strip line 116b connected to the second input/output terminal IO₂ of BALUN chip 140. A transmission signal input to the second input/output terminal IO₂ via second strip line 116b is output to first strip line 116a connected to first input/output terminal IO₁₋₁ of BALUN chip 140.

Radiation plate 120 is a metal plate having good electrical conductivity and may be formed in a rectangular shape. Radiation plate 120 is disposed to cover ground pad 112 and power supply pad 114. Accordingly, a ground unit of radiation plate 120 is bonded to ground pad 112. A power supply unit of radiation plate 120 is bonded to power supply pad 114.

As described above, BALUN chip 140 includes first input/output terminal IO₁₋₁ to which first strip line 116a is connected and second input/output terminal IO₂ to which second strip line 116b is connected. BALUN chip 140 further includes a third input/output terminal IO₁₋₂ to which a resistor 150 is connected. In this case, it is preferable that resistor 150 has a nominal resistance of 50 ohms (Ω) suitable for transmitting and receiving of an RF signal. Transmitting and receiving processes in inner antenna 200 according to the present invention having the above structure are as follows.

In the receiving process, a signal received through radiation plate 120 is input to the duplexer 130 via first strip line 116a, the BALUN chip 140, and the second strip line 116b. A transmission process is converse to the receiving process. A signal to be transmitted from duplexer 130 is input to radiation plate 120 via second strip line 116b, BALUN chip 140, and first strip line 116a.

Particularly, because BALUN chip 140 performs the function of a transformer in the process of transmitting a signal from power supply pad 114 (50Ω) to air (277Ω) through radiation plate 120, BALUN chip 140 can slowly change impedance. Thereby, performance deterioration due to abrupt impedance change, as occurs in the related art, is reduced. Slow impedance change allows the slow rate of change of the impedance locus in a frequency, thereby expanding the bandwidth of inner antenna 200.

According to the structure of the present invention, it is possible to expand the frequency band of an inner antenna by applying a BALUN chip between strip lines connecting the radiation plate and the duplexer to each other. Therefore, even if a frequency shift due to an effect of the human body is generated, the expanded frequency band covers the generated frequency shift, so that performance deterioration is minimized and thus a stable antenna performance is maintained. Because the frequency band of the inner antenna is expanded, various frequency bands can be covered with one inner antenna.

Although exemplary embodiments of the present invention have been described in detail hereinabove, it should be clearly understood by an artisan of ordinary skill in the art that many variations and modifications of the basic inventive concepts herein taught still fall within the spirit and scope of the present invention, as further defined by the appended claims.

What is claimed is:

1. An inner antenna of a mobile terminal using a BALUN (balance-to-unbalance transformer) comprising:
a wiring substrate provided within a main body of the mobile terminal and having a ground pad and a power supply pad on a surface thereof;
a radiation plate bonded to the ground pad and the power supply pad and separated from the surface of the wiring substrate and;
a plurality of strip lines including a first strip line and a second strip line, the first strip line coupled to the power supply pad and the second strip line coupled to a duplexer; and
a BALUN chip connected to the first and second strip lines.

2. The inner antenna of claim 1, wherein the first strip line coupled to the power supply pad is further coupled to a first input/output terminal of the BALUN chip, and the second strip line coupled to the duplexer is further coupled to a second input/output terminal of the BALUN chip.

3. The inner antenna of claim 2, wherein the BALUN chip further comprises a third input/output terminal to which a resistor is coupled.

4. The inner antenna of claim 3, wherein the resistor has a nominal resistance of 50 ohms (Ω).
